(19) United States
(12) Patent Application Publication
(10) Pub. No.: US 2006/0007645 A1
(43) Pub. Date: Jan. 12, 2006

(54) Foldable computer cover

(75) Inventors: Ching-Jou Chen, Taipei (TW); Tzu-Wei Lai, Taipei City (TW); Tsung-Kai Cheng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 11/047,699

(22) Filed: Feb. 2, 2005

(30) Foreign Application Priority Data
Jul. 9, 2004 (TW) 093210862

(51) Int. Cl. G06F 1/16

(52) U.S. Cl. 361/681

(57) ABSTRACT

A foldable computer cover includes: a first panel, a second panel, a third panel, a fourth panel, and a fifth panel, wherein a front end of the fifth panel is foldably connected to a back end edge of the fourth panel, a front end of the fourth panel is foldably connected to a back end edge of the third panel, and so on, so all the panels are connected together. The user can open the first panel and fold it to support the portable computer, and places the bottom of the portable computer along one of the stop ridges of the saw-toothed shaped stop on the third panel to hold the portable computer upright. The user can choose different stop ridges for placement of the portable computer at different viewing angles.

### BACKGROUND OF THE INVENTION

1. Field of the Invention

The present invention relates to a foldable computer cover and, more particularly, to a multifunctional foldable computer cover for a portable computer, such as a tablet PC, a web pad, a PAD, etc.

2. Description of the Related Art

Currently, a tablet PC provides portability with a handwriting touch control screen; however, the handwriting recognition software support in this device is not very helpful, and users usually connect the tablet computer to a keypad for extended writing sessions.

The prior art tablet computer is connected to the keypad via a USB plug, or with standard infrared technology. Because the tablet computer has no support structure, the user may need to assemble an external support. In order to protect and carry the tablet computer, the typical tablet computer comes with a bag to store and carry any peripheral equipment. However, the assembly process may increase the chances of dropping the tablet computer.

Therefore, it is desirable to provide a foldable computer cover to mitigate and/or obviate the aforementioned problems.

### SUMMARY OF THE INVENTION

In order to improve the above-mentioned problems, the present invention provides a foldable computer cover. When a user wants to open the cover, he or she opens all of the panels and places the bottom of the portable computer along one of the stop ridges of the saw-toothed shaped stop on the third panel to hold the portable computer upright. The user can choose different stop ridges for placement of the portable computer at different viewing angles. Consequently, the portable computer can be combined with the cover for display purposes.

The foldable computer cover comprises: a first panel, a second panel, a third panel, a fourth panel, and a fifth panel, wherein a front end of the fifth panel is foldably connected to a back end edge of the fourth panel, a front end of the fourth panel is foldably connected to a back end edge of the third panel, and so on, so all the panels are connected together. These five panels all are composed of an internal hard panel such as iron, aluminum, hard board or any other equal hard panel, covered with a soft cover such as plastic cloth, rubber cloth, cloth or any other equal soft materials. Furthermore, the fifth panel comprises at least one clasping element on an inside face corresponding to a attaching element on the back face of the first panel, and the attaching element of the first panel and the clasping element of the fifth panel are capable of locking to each other.

The user can open the first panel and fold it to support the portable computer, and places the bottom of the portable computer along one of the stop ridges of the saw-toothed shaped stop on the third panel to hold the portable computer upright. The user can choose different stop ridges for placement of the portable computer at different viewing angles.

Other objects, advantages, and novel features of the invention will become more apparent from the following detailed description when taken in conjunction with the accompanying drawings.

### BRIEF DESCRIPTION OF THE DRAWINGS

FIG. 1 is a perspective drawing of a preferred embodiment according to the present invention.

FIG. 2 is a side view showing the preferred embodiment in a closed condition according to the present invention.

FIG. 3 is a side view showing the preferred embodiment according to the present invention.

FIG. 4 is a system structure drawing of the preferred embodiment according to the present invention.

### DETAILED DESCRIPTION OF THE PREFERRED EMBODIMENT

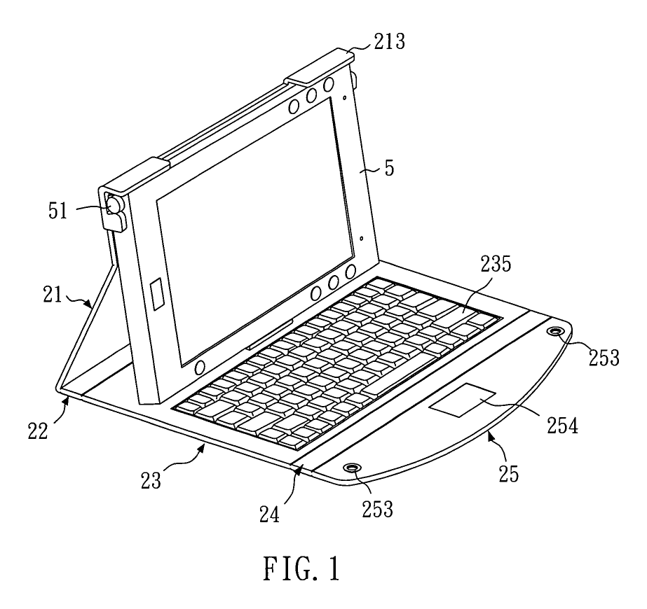

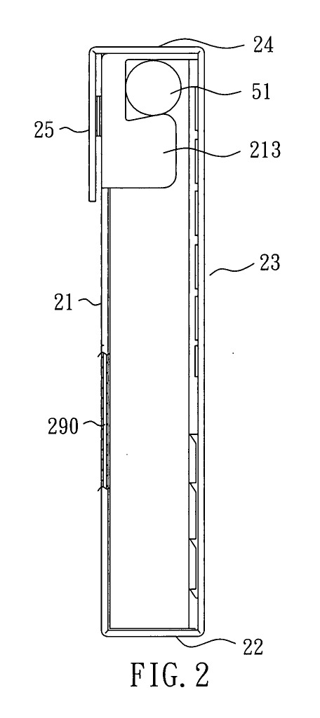

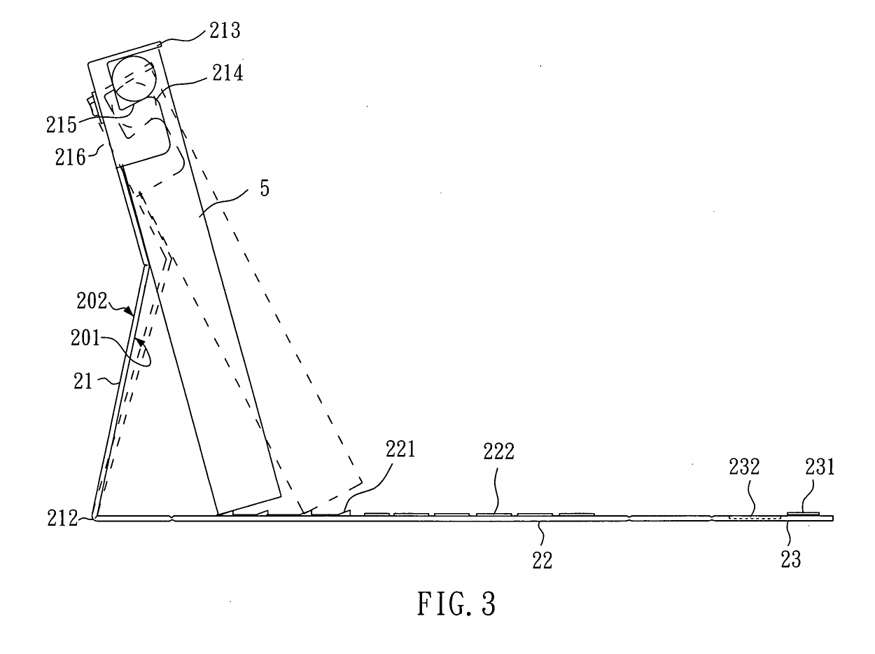

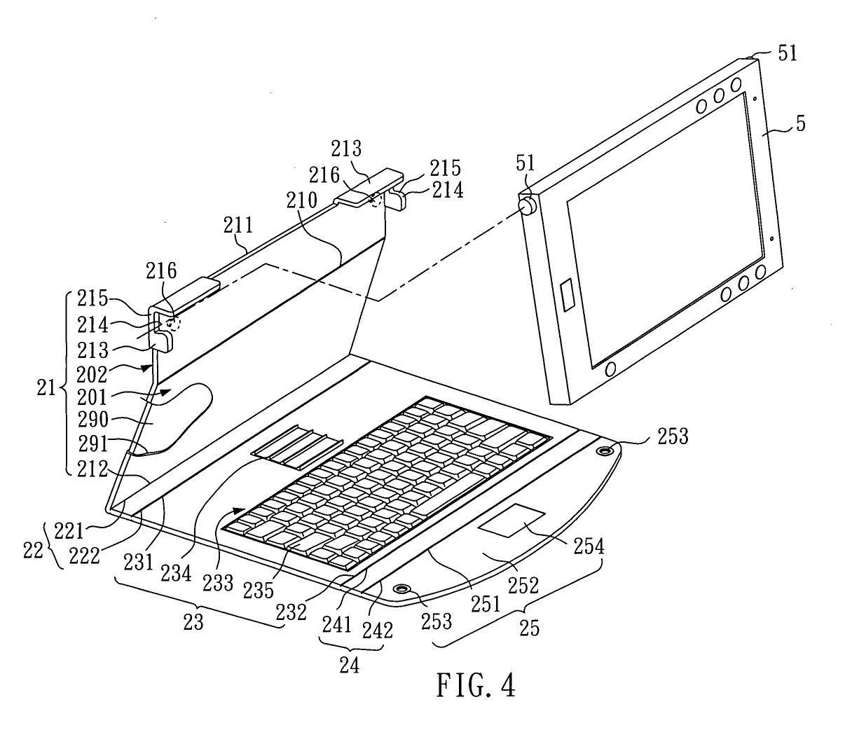

Please refer to FIG. 1, FIG. 2, FIG. 3, and FIG. 4. In this embodiment, a foldable computer cover is composed of five panels 21, 22, 23, 24, 25, which all comprise an internal hard panel 290 covered by a soft cover 291 (as shown in FIG. 4). For example, the internal hard panel 290 is made of plastic, and the soft cover 291 is made of leather to provide a more appealing texture.

In this embodiment, a front edge 211 of the first panel 21 has two fastening portions 213 at two sides of its front end edge; the fastening portions 213 protrude from an edge of an inside face 201 of the first panel 21, and are used for receiving a portable computer. In this embodiment, a tablet computer 5 is used as the portable computer. Another side of the first panel 21 further comprises a back end edge 212, and two attaching elements 216 on its back face 202. The first panel 21 also comprises a middle fold-line 210 placed between the front end edge 211 and the back end edge 212. The first panel 21 can be folded along the middle fold-line 210 so that the bottom of the tablet computer 5 can be placed against a stop 234 on the third panel 23. In this manner the tablet computer 5 is held still on the third panel 23 (as shown in FIG. 1).

Each fastening portion 213 of the first panel 21 further comprises a slot 215. The slot 215 has an outer opening 214. A pivot 51 is disposed on each of two sides of the tablet computer 5, and passes through the respective opening 214 to correspondingly engage with the slot 215. The tablet computer 5 can thus be rotated relative to the first panel 21 around the pivots 51.

In this embodiment, a front end edge 221 of the second panel 22 is foldably connected to the back end edge 212 of the first panel 21, and the second panel 22 further comprises a back end edge 222.

A front end edge 231 of the third panel 23 is foldably connected to the back end edge 222 of the second panel 22, and the third panel 23 further comprises a back end edge 232 and a stop 234 on its inside face 233. The stop 234 of the third panel 23 comprises at least two stop ridges to form a saw-toothed shaped stop 234, which provides different viewing angles for the tablet computer 5. In this embodiment, the stop 234 is made of rubber or plastic so as to avoid scratching the tablet computer 5. Additionally, the third panel 23 has a keypad 235, a touch tablet or other equivalent input device.

A front end edge 241 of the fourth panel 24 is foldably connected to the back end edge 232 of the third panel 23, and the fourth panel 24 further comprises a back end edge 242.

A front end edge 251 of the fifth panel 25 is foldable connected to the back end edge 242 of the fourth panel 24, and the fifth panel 25 further comprises two clasping elements 253 on its inside face 252 corresponding to the two attaching elements 216 on the back face 202 of the first panel 21 to close the entire cover and to provide for easy carrying (as shown in FIG. 2). The clasping elements 253 and the attaching elements 216 are respective male and female push bottom capable of locking to each other. Furthermore, the inside face 252 of the fifth panel 25 further comprises a touch pad 254 or another equivalent input device.

When a user wants to open the cover, he or she opens all of the panels and places the bottom of the tablet computer 5 along one of the stop ridges of the saw-toothed shaped stop 234 on the third panel 23 to hold the tablet computer 5 upright. The user can choose different stop ridges for placement of the tablet computer 5 at different viewing angles (as shown in FIG. 3). Consequently, the tablet computer 5 can be combined with the cover for display purposes.

As shown in the above description, the foldable computer cover has the following benefits:
(1) Different stop ridges provide different viewing angles for the tablet computer (portable computer).
(2) Reduced chances of dropping the tablet computer (portable computer).
(3) Easy operability and storage of the tablet computer (portable computer).
(4) Increased convenience and safety when displaying the tablet computer (portable computer).
(5) Increased operational convenience.

Although the present invention has been explained in relation to its preferred embodiment, it is to be understood that many other possible modifications and variations can be made without departing from the spirit and scope of the invention as hereinafter claimed.

What is claimed is:

1. A foldable computer cover comprising:
a first panel having two fastening portions on two sides of a front end edge, the fastening portions protruding from an inside face of the first panel and used for receiving a portable computer, the first panel further comprising a back face, a back end edge and at least one attaching element on said back face;
a second panel having an edge foldable connected to the back end edge of the first panel, the second panel further comprising a back end edge;
a third panel having a front end edge foldably connected to the back end edge of the second panel, the third panel further comprising an inside face, a back end edge and a stop on said inside face;
a fourth panel having a front end edge foldably connected to the back end edge of the third panel, the fourth panel further comprising a back end edge; and
a fifth panel having a front end edge foldably connected to the back end edge of the fourth panel, the fifth panel further comprising an inside face, and at least one clasping element on the inside face corresponding to the at least one attaching element on the back face of the first panel.

2. The foldable computer cover as claimed in claim 1, wherein the at least one attaching element of the first panel and the at least one clasping element of the fifth panel are respective male and female push bottom capable of locking to each other.

3. The foldable computer cover as claimed in claim 1, wherein each fastening portion of the first panel comprises a slot, the slot having an outer opening thereof, two pivot blocks are disposed on two respective sides of the portable computer and respectively pass through the outer openings and correspondingly engage with and pivot in the slots.

4. The foldable computer cover as claimed in claim 1, wherein the first panel further comprises a middle fold-line disposed between the front end edge and the back end edge.

5. The foldable computer cover as claimed in claim 1, wherein the stop of the third panel comprises at least two stop ridges.

6. The foldable computer cover as claimed in claim 1, wherein the third panel further comprises a keypad mounted on the inside face of the third panel.

7. The foldable computer cover as claimed in claim 1, wherein the fifth panel further comprises a touch pad mounted on the inside face of the fifth panel.

8. The foldable computer cover as claimed in claim 1, wherein each panel of the first panel, the second panel, the third panel, the fourth panel, and the fifth panel is composed of an internal hard panel covered with a soft cover.

9. The foldable computer cover as claimed in claim 8, wherein the internal hard panel is a plastic panel, the soft cover is a leather cover.
